(19) United States
(12) Patent Application Publication
(10) Pub. No.: US 2009/0015875 A1
(43) Pub. Date: Jan. 15, 2009

(54) IMAGE MANIPULATION OF DIGITIZED IMAGES OF DOCUMENTS

(75) Inventor: David D. S. Poor, Meadowbrook, PA (US)

Correspondence Address: ROTHWELL, FIGG, ERNST & MANBECK, P.C., 1425 K STREET, N.W., SUITE 800, WASHINGTON, DC, 20005, US

(73) Assignee: CTB/McGraw-Hill Companies, Inc., Monterey, CA (US)

(21) Appl. No.: 12/142,468

(22) Filed: Jun. 19, 2008

Related U.S. Application Data
(60) Provisional application No. 60/945,165, filed on Jun. 20, 2007.

(51) Int. Cl. H04N 1/00

(52) U.S. Cl. 358/403

(57) ABSTRACT

A system and method for reading into memory a plurality of scanned image files, obtaining a set of parameters describing the extent to which each scanned image file deviates from a theoretical image file, wherein the set of parameters includes at least one of a horizontal offset, a vertical offset, a horizontal stretch, a vertical stretch, or skew, manipulating a first scanned image file from the plurality according to the set of parameters for the scanned image file, reading into memory a manipulation control, conditionally manipulating a second scanned image file from the plurality based on a value of the manipulation control, and saving at least one manipulated image.

### RELATED APPLICATIONS

Pursuant to 35 U.S.C. § 119(e), this application claims priority to U.S. Provisional Patent Application Ser. No. 60/945,165 filed on Jun. 20, 2007 the entire contents of which is incorporated herein by reference.

### FIELD OF THE INVENTION

This invention relates to the general field of manipulating stored digital images from documents, and within that field to enhanced methods and apparatus for modifying images to be best suited for subsequent viewing or other uses including by humans and automated processes.

### BACKGROUND OF THE INVENTION

As shown in the co-pending application (Poor, U.S. Patent Application Publication No. 20040131279 (“Poor '279”), the disclosure of which is herein incorporated by reference, images that are captured from scanners that may not have the precision of dedicated OMR scanners may be distorted, and such distortions may make the images unsuitable for subsequent uses. There is, therefore, a need to correct such distortions. This invention teaches how to significantly reduce computational needs to make such corrections by utilizing parameters calculated or otherwise determined during the data extraction process.

Following the mantra of the “paperless office” and the “paperless society,” more and more of our critical records are being stored in digital format. While some records originate as digital documents, many records are based on paper documents. These paper documents are scanned, typically using an image scanner, and the scanning hardware provides a digital representation of the original document.

As many companies have learned, there are often problems with the scanned images and both hardware and software vendors have had to develop sophisticated image analysis and manipulation systems to ensure that the images would be viable alternatives to the original paper. Often scanned images were rotated or “skewed” so that the images needed to be deskewed to be properly aligned. Sometimes the images were too dark or too light or the contrast between the paper and the marks was insufficient so that complex analysis and rescaling procedures were required. In fact, there is now a significant industry of software and hardware providers specializing in image analysis and manipulation targeted largely to allow correction of poor document images.

In education, assessment instruments are still largely administered with paper and pencil “tests.” As shown in Poor '279, there are traditional “dedicated OMR systems” to ensure that intended answers to multiple choice or selected choice items can be utilized, but such methods require extremely expensive documents.

In addition to capturing data from assessment documents, typically test books, education makes significant use of captured images in scoring of open-ended or “constructed” responses. As shown by Poor (U.S. Pat. No. 5,672,060, the disclosure of which is hereby incorporated by reference), the digitized images of student responses can be used to assign scores to each student's performance in response to each task. In fact, this use of images has become the standard for most high stakes assessments such as those developed to meet the requirements of the “No Child Left Behind” mandates. However, when used in conjunction with lower quality documents, distortions in the images may jeopardize the suitability of the images for scoring.

A third application of captured images in the education field is relatively new and is based on the successful archival use of electronic images in other industries. Already, all 50 states accept digitized images as legitimate alternatives to paper documents and many businesses and governments have established significant digital archives to replace paper-based long-term storage. The significant developments in image manipulation of scanned documents have largely been developed in response to the needs of businesses and governments thereby indicating that such archival use with assessments will require the same image manipulations as used in other businesses and governments.

A major problem for these uses relates to the sheer volume of assessment documents that are processed: a single statewide contract may include over a million assessments with tens of millions of sheets of paper. With this volume, the traditional solutions to “fix” poor images become impractical as such solutions require extensive computer resources and investment in infrastructure to perform sophisticated analyses of the images in addition to any image manipulation. This invention, then, enables the “fixing” of poor images with significantly reduced demands on computer resources and infrastructure.

### SUMMARY OF THE INVENTION

This invention is concerned primarily with utilizing the parameters needed to “fix” images so that they can be suitable for archiving, scoring of open-ended responses, or other uses. As shown in “Enhanced data capture from imaged documents” (Poor '279), while extracting data from the documents, the extraction process can calculate or otherwise determine parameters that describe the distortion of the images including skew, stretch, and location, both in the horizontal and vertical dimensions. This current invention shows how those same parameters can be used to “fix” images.

In an embodiment of the current invention, calculated and otherwise determined parameters from the scanning and data extraction process are saved so that they can be subsequently utilized to “fix” the images without the computationally expensive requirement to recalculate the parameters based on the saved images. As shown in the Poor '279, “ . . . once the nominal locations are located, for each OMR position, the actual horizontal and vertical locations are set by adjusting the nominal locations by the calculated parameters including the Sheet Position Parameters, the Speed Parameters, and the Key Mark Parameters. These parameters permit adjustment for horizontal and vertical stretch and skew as well as adjustments for the location of the form within the captured image.” These same parameters can be used to “fix” the saved images, i.e. to manipulate the image so that its characteristics such as orientation, location, and size correspond to the theoretical values for a scanned document. As shown in Poor '279, extensive computer cycles are needed to perform such manipulations and therefore this is not feasible within a high speed scanning environment. Certain embodiments of this invention utilize an application program, typically running on a second computer system, to provide the image manipulation.

One embodiment of this invention, then, includes scanning a document, and capturing the digitized image of the scanned document within a computer system. Then, that same computer system is used to calculate a set of parameters that describe the extent to which the scanned image deviates from a theoretical image as taught by Poor '279. The same computer system is then used to write out a copy of the full image or a region of interest within the image to a digital storage device such as a hard drive or CD which is directly or indirectly connected to the computer. All of these steps are taught by Poor '279.

In one embodiment of the invention, some or all of the calculated parameters are also written out to a digital storage device or transmitted directly to a second computer. These parameters can be stored as part of the image itself, such as with custom tags within a TIFF image, or within a separate digital file. In one embodiment of the invention, each image is stored in a separate file, and an ancillary “index file” is written which contains, among other items, the name of the image file and a selected subset of the calculated parameters.

The invention provides a method to then “fix” the digitized image to more closely match the theoretical image specifications using specifications such as the size of the image area, the location within the image area, the orientation or rotation within the image area, and the extent within the image area. Using the application program, external criteria are used to build appropriate business rules to determine which, if any, image manipulations will be “fixed.” In one embodiment, these criteria are stored in four locations including the default values built into the application program, and three control files used during processing.

Based on the criteria and business rules, one or more image manipulation steps may be invoked for each digitized image that needs to be “fixed.” In one embodiment, each digitized image is identified as a separate entry in the index file. For each image, the image is read into the application program, and the subset of calculated parameters is read from the index file. Then the business rules are applied to determine which, if any, image manipulations are required. This disclosure then shows how such image manipulation steps can be implemented without further analyzing the image. Such manipulation can include steps such as rotating the image, stretching or shrinking the image in either horizontal or vertical dimensions, changing the resolution of the image, expanding or shrinking the total image area, and repositioning the image within the image area to a specific horizontal and/or vertical position.

According to the business rules, there may be instances in which an image needs to be “fixed,” but, for one or more of the manipulations, the needed control parameters are not available from scanning. In such instances, the application will need to perform a subset of the image analysis routines to determine the appropriate value for the missing calculated parameter.

While there are extensive systems available to analyze images which can be utilized to determine which image manipulation steps are required, the analysis is generally computationally intensive. With the hundreds of thousands of images utilized in assessment processing, the current invention provides an alternative which permits the same image manipulation without the extensive overhead.

Although the disclosure is primarily directed at processing assessment documents, the methods and apparatus can be used to provide image corrections for any scanned document or other scanned image.

### BRIEF DESCRIPTION OF THE DRAWINGS

FIG. 1 is a block diagram of a method for resolving an OMR response position.

FIG. 2 is a schematic of a system to implement the method of FIG. 1 to resolve an OMR position with the addition of both files containing digitized images and an index file.

FIG. 3 shows a sample index file containing a subset of calculated parameters.

FIG. 4 shows sample control files containing criteria.

FIG. 5 is a schematic of a system to manipulate saved digitized images.

FIG. 6 is a block diagram of a method for processing image files.

FIG. 7 is a table of the image manipulations applied to the images in the sample index file.

FIG. 8 shows a scanned document with image rotation manipulations.

FIG. 9 shows images of a scanned document before and after image transformation changing the image from a gray-scale image to a bitonal image.

### DESCRIPTION OF THE EMBODIMENTS

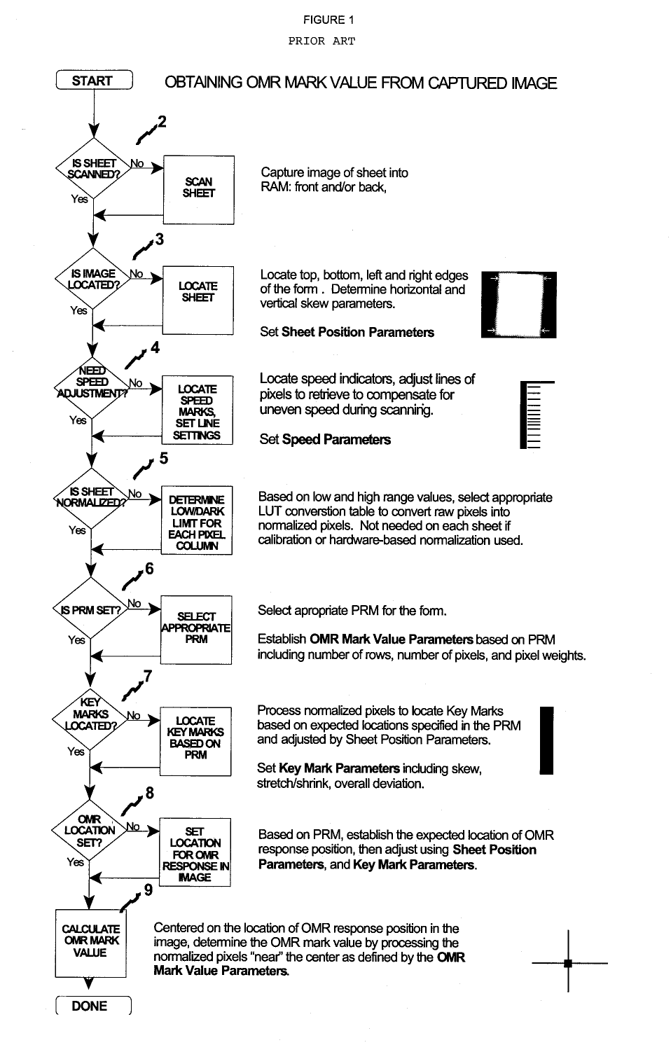

The invention is described in embodiments for manipulating images of scanned assessment documents by utilizing parameters calculated during the processing of OMR response forms with an imaging scanner to identify and resolve intended response marks on the form. The steps utilized in the a typical embodiment to process the form for intended marks summarized in FIG. 1 are described in Poor “Enhanced Data Capture From Imaged Documents” (U.S. Patent Application Publication No. 20040131279) (“Poor '279”).

As described in Poor '279, the resolution of OMR marks follows a series of steps used to “ . . . determine parameters with which to adjust the expected location of an OMR target or other area of interest. An adjustment to the expected location could be made from any of the parameters alone or in various different parameter combinations.”

Poor '279 also teaches the concept of a theoretical “idealized captured image.” “The idealized image assumes that the physical form actually being scanned corresponds exactly to the dimensions and layout of the intended form, i.e. perfectly registered printing, exact sizing, and no shrink/stretch or other distortion from humidity, crumpling, or other source. The idealized image further assumes perfect quality control of the scanning process, i.e. no sheet skew, no scanning angle or distance errors, no distortion caused by scanning speed variances, and the like. Thus, the idealized captured image corresponds to the image that would theoretically be captured if the perfect form is scanned by the perfect scanning process.”

While in Poor '279, the calculated parameters (3, 4, 6, and 7) are utilized to locate certain region of interest areas (8) and then extract data from those areas (9), the current invention uses those same calculated parameters to manipulate the captured image to more closely match the theoretical or “idealized captured image.”

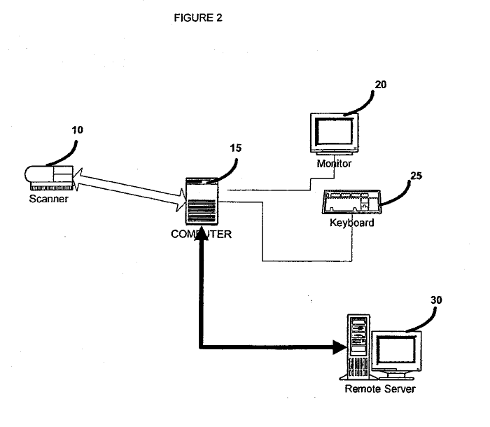

FIG. 2 shows a computer hardware system used to scan the images and calculate the parameters. In one embodiment, there is an image scanner (10) connected via a high speed digital path to a computer (15) which consists of at least a central processing unit (CPU), working memory, and mass storage device, typically a hard drive. There may also be a specialized hardware board within the computer (15) to facilitate the transfer of data to and from the scanner (10) similar to the controller circuitry allowing data transfer from the computer working memory to the hard drive. The computer (15) will generally also have at least one monitor (20) and a keyboard (25) to allow interaction with the scanning operator. In most cases, the computer (15) will also contain hardware to connect it (15) to a network, often a local area network, using appropriate cables and protocols such as TCP/IP running over Ethernet 100 or 1000.

In one embodiment of the invention, the parameters are calculated or otherwise determined using a software program within the computer (15) as taught by Poor '279. Then, for those captured images which will be required for one or more purposes after the scanning is complete, the required images are written to the mass storage within the computer system (15) or, over a network connection to an external mass storage device such as a hard drive on an external server (30). Each image may be a complete scanned page or a subset of a page or Region of Interest (ROI). Each image may be written to a separate file or multiple images may be combined into a single file of multiple images.

In addition to writing out the images, one embodiment of the invention requires that the software running on the computer (15) also save digital representations of at least some of the calculated or otherwise determined parameters to be subsequently available to facilitate the manipulation of the stored image to correct distortions or other deviations from the theoretical or ideal image of the original sheet of paper. In one implementation of the invention, each image is saved as a separate image file, and the digital representations of the parameters for each image are stored in a separate record in an “index file.” Each record also has the name of the corresponding image file and other fields that identify the image. In one embodiment of the invention, this index file is stored as a delimited file and is used to identify the names of all the image files that need to be processed.

While not required, parameters can include additional information or “metadata” about the image which can also be stored. Such additional information may include the height and width of the image, the resolution of the saved image, the depth of the image, the date and time that the image was created, the format used to save the image, which Predetermined Response Matrix (PRM) was used to decode the OMR values from the image, or other relevant metadata. In the image manipulation, any of these parameters may be changed to meet business rules or specifications for the final “fixed” image.

As an alternative implementation, the parameters can be stored within the image files themselves, such as with custom tags within a Tagged Image File Format (TIFF) image file. In such an implementation, the manipulation program can merely interrogate all the image files within a specified directory and/or with specified filemask search selection criteria to identify all of the images to be processed and thereby obviate the need for a separate index file.

As yet another alternative implementation, the parameters and other metadata can be sent directly to the second computer. Such information may be stored in a queue in memory, saved on a digital storage device such as a hard drive, or other appropriate intermediate storage until the image is processed.

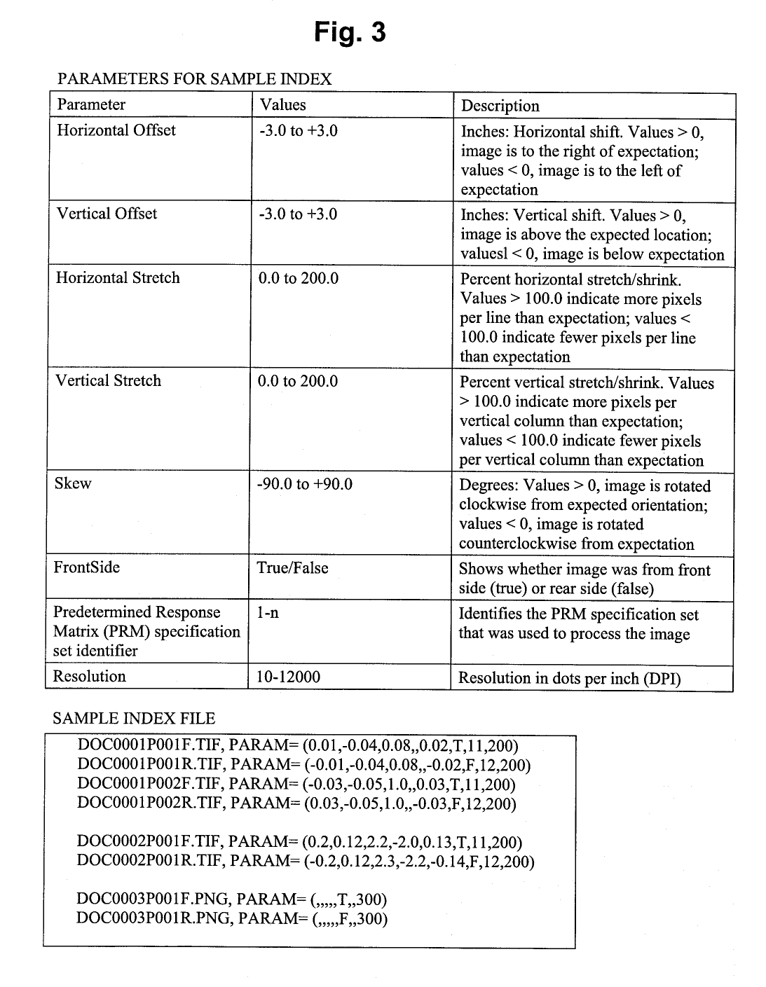

FIG. 3 shows a series of field identifiers for an index file and a sample index file. As shown in the table on the top (50), there are eight image parameters selected for this sample implementation: horizontal offset; vertical offset; horizontal stretch; vertical stretch; skew; frontside; Predetermined Response Matrix (PRM) specification set identifier; and resolution. All but two of these are calculated parameters as taught by Poor '279. The exceptions are the parameter “FrontSide,” which indicates which side of the scanned sheet the image file represents, and the parameter “Resolution”, both of which are assumed to be known by the scanning program as taught by Poor '279.

The second part of the figure (55) shows sample saved parameter values for three different documents. The documents are identified as DOC0001, DOC0002, and DOC0003. The first document (60) contains two sheets, with a total of four sides identified as P001F for the front of the first sheet, P001R for the back side of the first sheet, and continuing for P002F and P002R for the front and back of the second sheet. The second document (65) contains both sides of a single sheet, and the third document (70) contains both sides of a single sheet. For each side of each sheet, the line in the index file contains the file name of the file containing the image, the image format identifier (TIF or PNG file extensions in this example, to represent TIFF and PNG formats), as well as the parameters which are within a subsection identified as PARAM and containing eight comma delimited values. When a value is undefined, it is omitted, but the omission is shown by the appropriate (comma) delimiter.

The values of the first document are typical of what might occur with documents with traditional timing tracks that are processed as shown by Poor '279. In these documents, the vertical position of each row of marks is located by the presence of a small rectangle or “timing track.” Looking at the saved parameter values, the first parameter, horizontal offset, has values of 0.01, −0.01, −0.03, and 0.03 for the four images from document 1. These values are typical of what will be observed from printed documents and show that the front offset and horizontal offset are often complementary. The second parameter (vertical offset) values of −0.04, −0.04, −0.05, −0.05 indicate that the images are all positioned slightly lower than would be expected. Such vertical offsets are often similar from the front to the back of any given sheet, but may show significant differences depending on the technology used to produce the document. The third parameter (horizontal stretch) with values of 0.08, 0.08, 1.0, 1.0 shows horizontal lines with near zero percent and one percent more pixels than would be expected for the two sheets and shows that these values are often the same for the front and back of any given page. The fourth parameter is omitted for all four rows as the track-based processing does not necessarily calculate vertical stretch. The fifth parameter shows the skew with values of 0.02°, −0.02°, 0.03°, and −0.03°. These values show slight clockwise rotation on the front sides and corresponding counter-clockwise rotation on the backs. The sixth parameter shows T, F, T, F to indicate the appropriate front or rear, and with T representing FRONT=True, and F representing FRONT=False. The seventh parameter shows which PRM was used for each image with PRM 11 being used for the front and PRM 12 being used for the rear. The last parameter shows the resolution of the saved image as 200 DPI for the first six TIFF images and 300 DPI for the two final PNG images.

The second document is typical of one with key marks in four corners of the sheet so that horizontal and vertical measurements can be accurately calculated as shown by Poor '279. These stored calculated parameters are all present and show both horizontal and vertical stretch in excess of 2 percent.

The third document's index file entries are typical of those processed by traditional means for which the calculated parameters are not available. In the index records for these images, only the front/rear flag, parameter 6, and the resolution, parameter 8, are available and all other values are omitted.

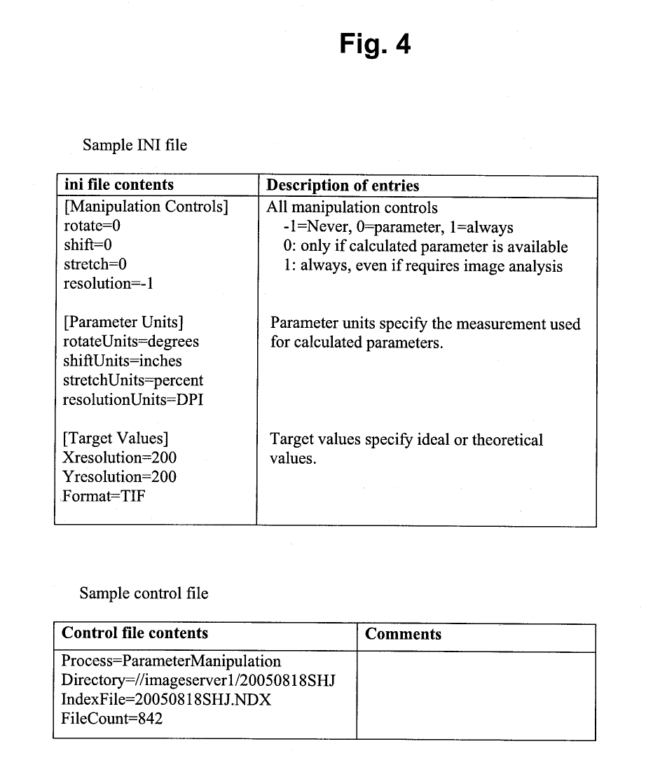

FIG. 4 shows sample control files. In one embodiment, there are two optional “ini files” associated with the program: the first in the directory containing the executable program, and the second in the target directory containing the image files, but such control information could be stored in other forms such as in the computer operating system's registry or in a database. In one embodiment, both of these ini files have identical content and serve to override the program default values with the second ini having precedence. The top part of FIG. 4 (80) shows sample content for an ini file along with comments on the values.

The main portion of the sample ini file is the [Manipulation Controls] section (90) which specifies which manipulations will or will not be performed and under what conditions. In the sample, there are three possible values for each manipulation: −1 (never), 0 (parameter), and 1 (always). When the value is −1, the manipulation step is not used. The default value is 0, which indicates that the manipulation should always be performed when the needed calculated parameters are available, but not when the calculated parameters are missing. This setting takes maximum advantage of the calculated parameters saved in the index file and allows for manipulations with minimum computer overhead. The third value, 1, indicates that the manipulation must be performed for all images. In this case, when the required calculated parameters are not available from the index file, the program must perform image analysis to determine the needed values. This analysis may be computationally extensive. The savings in computer resources and time are significant when the calculated parameters are available in the index file.

In the sample ini file Manipulation Controls section (90), the rotate field is set to 0 so that the program will rotate or deskew the images whenever the required calculated parameters are available in the index file. In the case of rotation, only the skew parameter shown in FIG. 3 is required. The shift field is also set to 0 so that the image will be shifted horizontally and/or vertically whenever the required calculated parameters are available in the index file. In the case of shift, the horizontal offset parameter is used to determine the horizontal shift, and the vertical offset parameter is used to determine the vertical shift. The stretch field is also set to 0 so that the image will be stretched or shrunk horizontally and/or vertically whenever the required calculated parameters are available in the index file. In the case of stretch, the horizontal stretch parameter is used to determine the horizontal adjustment, and the vertical stretch parameter is used to determine the vertical shift. The one remaining manipulation shown in the sample ini file, resolution, is set to −1 so that it will not be performed.

The second part of FIG. 4 shows a sample program control file (85) used in an embodiment of the invention. In such an embodiment, a control file such as this is prepared and passed to the manipulation program although there are other ways to pass such control information including values in the operating system's registry, values in a database, individual values passed in the execution command line, and others. In the sample control file, a series of field/value pairs are shown. These fields identify the directory containing the image files and the index file (Directory) and the name of the index file (IndexFile) so that the program can locate all of the images and obtain all of the computed parameters. In addition, the FileCount field indicates the number of image files that need to be processed as a validation to ensure that the program correctly processes all files.

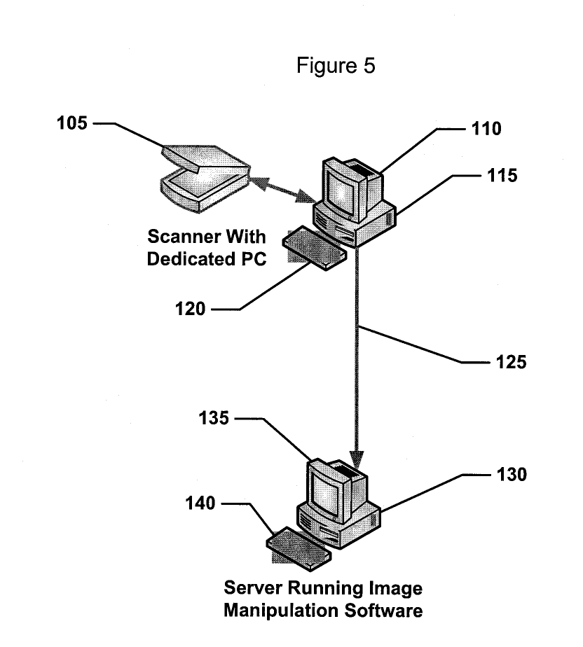

FIG. 5 shows a computer system suitable for performing the image manipulations. While the image manipulation computer (130) could be the same one as used in capturing the images as shown in FIG. 2, in the embodiment of the invention shown in FIG. 5, this computer (130) is a separate server. In the embodiment shown, the image files and the index file are transferred from the computer (115) attached to the scanner (105), keyboard (120), and monitor (110), to the image manipulation server (130) over a network connection (125) and stored on the hard drive of the server (130). While the image manipulation program could be launched by an operator using a keyboard (140) and monitor (135) attached to server (130), in the embodiment shown an external process automatically creates the control file and launches the program within the computer using the network connection (125).

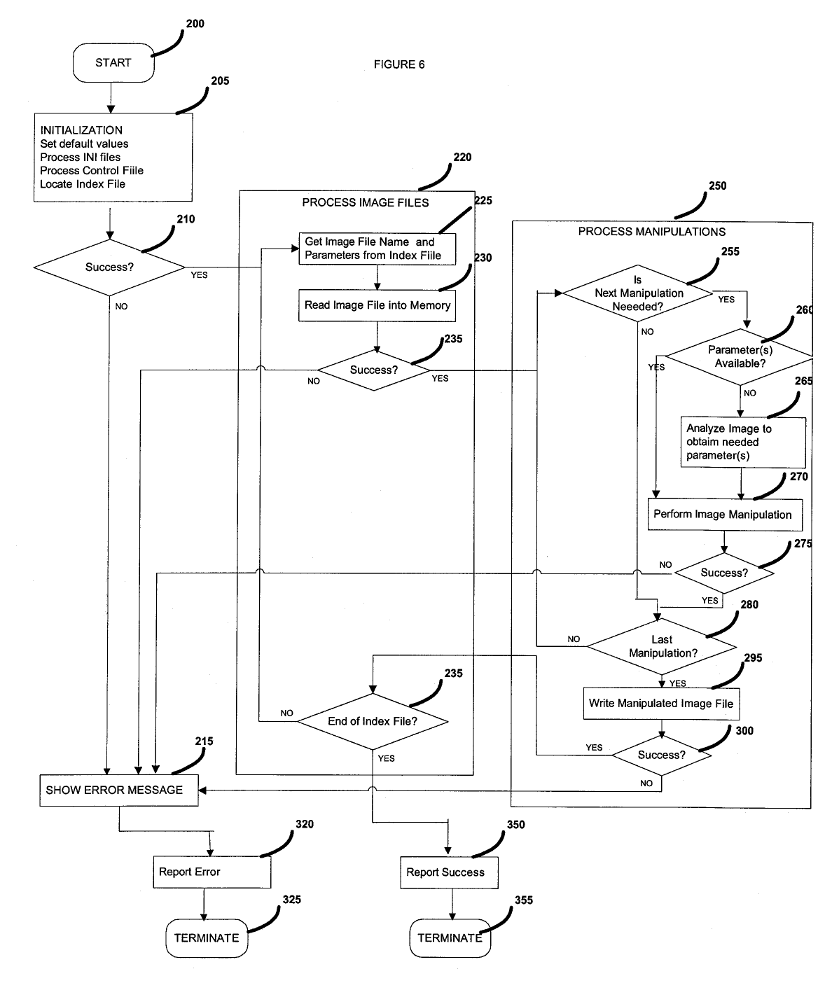

FIG. 6 shows a block diagram for the manipulation program. While this block diagram is based on the execution of a single program, similar functionality could be achieved by selectively executing multiple programs, possibly across several computers. Note also that the presentation here shows each manipulation as a discrete function and all manipulations are shown as being processed sequentially while it is possible to combine multiple manipulations into a single processing step such as shown in the Affine transformation by MCM design (http://www.mcm-design.com/).

FIG. 6 shows a single manipulation execution program that contains three main components. The first is the initialization portion and contains the program start (200), the initialization functions (205), and verification that the initialization was successful (210). The second is a loop that goes through all of the entries in the index file as shown in the PROCESS IMAGE FILES box (220). The third is for each image file and contains a loop going through all of the possible manipulations as shown in the PROCESS MANIPULATIONS box (250) and writing the manipulated image (295 through 300).

In the initialization, the main functions (205) include setting all control parameters. These include setting default values, overriding default values from the ini files, and obtaining the control settings from the control file. In any particular implementation of this invention, such initialization functions may vary. If the program is unable to properly initialize, the program is aborted (215, 320, 325).

In the one embodiment of the invention, the various image files are identified by the index file. This is shown in the PROCESS IMAGE FILES box (220). This is primarily achieved by reading in a record from the index file and parsing the record to obtain all stored calculated parameters and the name of the image file (225). Once the file name is determined, the program must also read the file into memory so that manipulations can be executed (230). In practice, the actual reading of an image file may be deferred until at least one manipulation is identified as being required. If there is a failure, the program can abort as shown in the block diagram (235) or set a flag to report all errors at the end of the run. After image manipulations on the first image are complete, the program continues through the remainder of the index file until all images have been processed (240).

For each image file successfully read, the block diagram shows a series of possible image manipulations in the PROCESS MANIPULATIONS box (250). The various manipulations may include rotating the image to remove skew, shifting the image left, right, up, and/or down to adjust for horizontal and/or vertical offsets, stretch or shrink the image in the horizontal and/or vertical dimensions to adjust for stretch/shrink, expand or shrink the image in the horizontal or vertical dimension to adjust the resolution, change the depth of the image, or other appropriate manipulations. For each manipulation within the set of potential manipulations supported by any implementation, the block diagram shows that the first step is to determine whether the manipulation is required for the image (255), and then whether image analysis is required to calculate needed but missing parameters (260). Using the sample controls in FIG. 4, there are four possible manipulations: rotation, shift, stretch, and resolution. In the ini settings as shown, the first three will be required only when the calculated parameters are present, and the last one will never be required.

There may be special instances such that images have calculated parameters that would otherwise be needed, but for which manipulations may be bypassed. Such examples might include precision documents scanned on precision scanning systems such that any distortions would be insignificant. Additional examples might include images that are electronically created such as images created to simulate scanned documents but that derive from students taking an assessment using a computer or other electronic device. In such circumstances, business rules can override the normal control parameters and indicate that one or more manipulations should not be done.

In the case in which a manipulation is both required (260) and the needed parameters are not available (in this case from the index file), analysis will also be required (265). When the analysis is required, the program must do an appropriate image analysis to obtain the needed but missing parameter. Although the block diagram shows this happening for each possible manipulation, in practice, a single image analysis step may be executed to calculate some or all needed but missing parameters.

Once the required parameter or parameters are available, either from saved calculated parameters or from image analysis, the image manipulation (270) is performed.

The above sequence for image manipulation is repeated for each potential manipulation until all potential manipulations have been examined and appropriately processed (280).

Once the list of potential image manipulations has been processed for an image, the program will generally write out the final manipulated image (295) provided that there were no fatal errors in the image manipulation process. If there is a failure either in the image manipulations or in writing the image, the program can abort as shown in the block diagram (275, 300) or set a flag to report all errors at the end of the run. After image manipulations of the image are complete, the program continues with the index file processing as described above.

The block diagram shows two possible outcome/exit conditions for the program. In the case of any failure, the program reports the failure (320) and terminates (325). In the case of no failure, the program reports success (350) and terminates (355). As stated above, it is not necessary to terminate immediately on any error and the program can alternatively create an error log and report failure if one or more errors are logged or use similar alternative processing so that all errors are identified as early as possible.

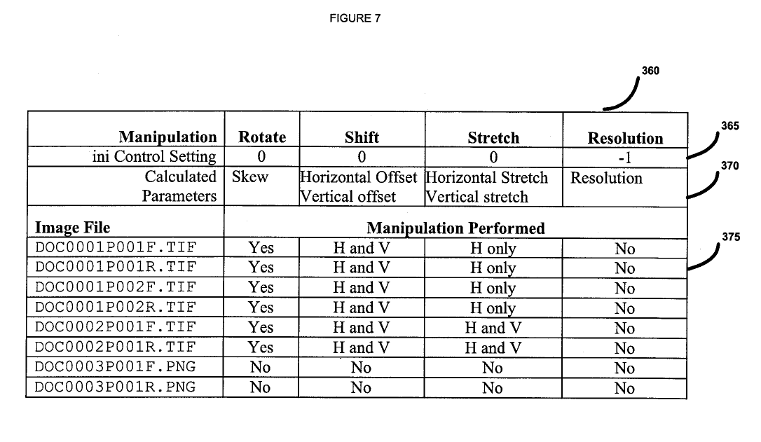

FIG. 7 shows the resulting image manipulations executed on each image file listed in the sample index file in FIG. 3 using the simplified block diagram in FIG. 6 with the control files in FIG. 4. The figure shows the four manipulations (360) shown in the ini file controls in FIG. 4. Based on the ini settings (365) taken from FIG. 4, up to three manipulations may be required for any image (rotate, shift, and stretch), and those will only be required if the calculated parameters (370) are present. The appropriate control parameters are skew (the fifth parameter in FIG. 3), for rotation, both horizontal and vertical offset (the first and second parameters), for shift, and both horizontal and vertical stretch (the third and fourth parameters). Based on the parameters shown in FIG. 3, the manipulations performed are as shown in the table entries (375).

For both rotate and shift, the required calculated parameters are available for the first six entries, and none are available for the final two entries. For stretch, the first four entries contain horizontal but not vertical stretch parameters, the next two entries contain both horizontal and vertical stretch parameters, and the final two entries contain neither. Because resolution is set to −1 in the ini file, there is no resolution manipulation.

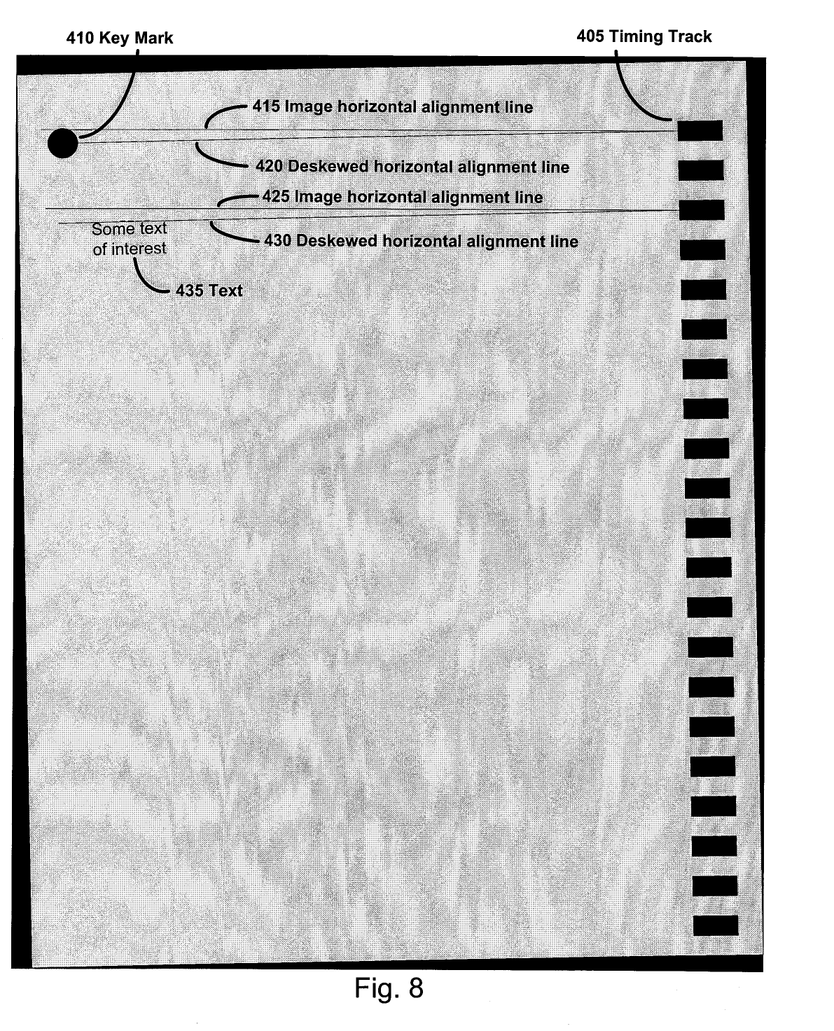

FIG. 8 shows an image to which image rotation manipulations are applied. In this example, page features (405) timing track and (410) key mark would have been previously used to produce and store within the index file the calculated parameter to identify the degree of image skew, as represented by the difference between the image horizontal alignment line (415) and the corrected horizontal alignment line (420). The resulting index file skew parameter can then be used to locate and “fix” additional areas of interest within the skewed image. In this example, the adjusted horizontal alignment line (430), as corrected from the unadjusted line (425), is used to locate text region of interest 435, which may then be “fixed” to correct the skew.

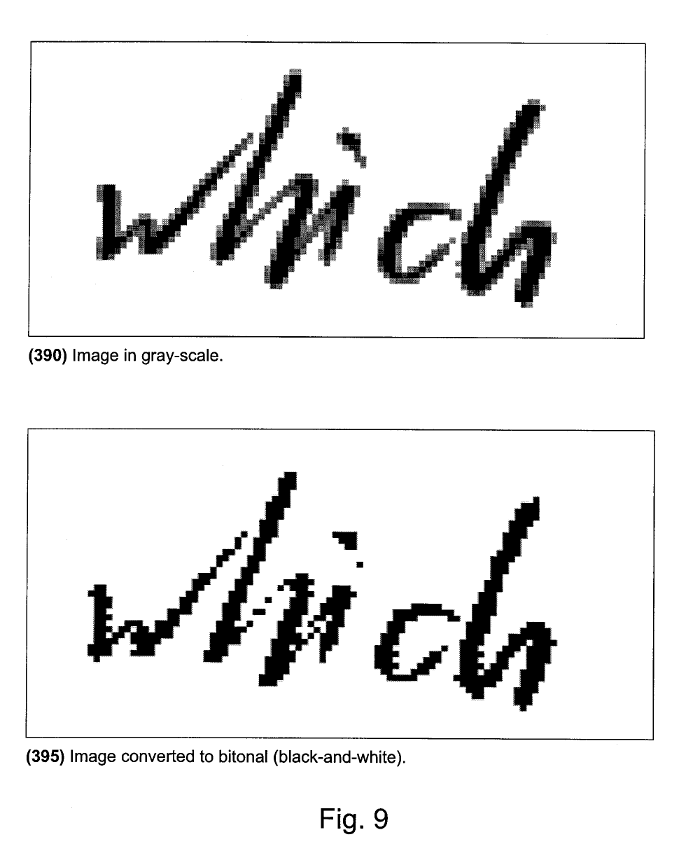

FIG. 9 shows an image section before (510) and after (520) application of image manipulations changing the image from a gray-scale image to a bitonal image. In the example shown, the scanned image is manipulated to convert gray-scale to a bitonal (black-and-white) rendering. This conversion compresses the image data, reducing storage requirements, and enables processing by automated recognition engines that may be limited to bitonal image data extraction, or that work more advantageously from a bitonal image than from a gray-scale image.

Note that the figures and explanations present only one possible implementation of this invention and those skilled in the art will quickly identify other solutions that will utilize the invention as well as enhancements and refinements to the simplified structures, data files, and processes shown in the figures. Although the methods and apparatus described herein may be useful in other related tasks, the most common usage is likely to be in scoring constructed responses based on captured digital images and in archiving of assessment documents.

1) A method of imaging a document, comprising:
reading into memory a plurality of scanned image files;
obtaining deviation parameters describing the extent to which each scanned image file deviates from an idealized captured image;
manipulating one or more of the image files according to the deviation parameters to generate a manipulated image file; and
saving each manipulated image file generated.

2) The method of claim 1, wherein the deviation parameters include at least one of a horizontal offset, a vertical offset, a horizontal stretch, a vertical stretch, skew, or resolution.

3) The method of claim 1, wherein the manipulating step comprises performing one or more manipulations from the group of manipulations consisting of:
rotating the image to remove skew,
shifting the image left, right, up, and/or down to adjust for horizontal and/or vertical offsets,
stretching or shrinking the image in the horizontal and/or vertical dimensions to adjust for horizontal stretch or shrink and/or vertical stretch or shrink; and
expanding or shrinking the image in the horizontal and/or vertical dimension to adjust the resolution or change the depth of the image.

4) The method of claim 1, wherein obtaining the deviation parameters comprises reading the deviation parameters from a stored index file.

5) The method of claim 1, wherein obtaining the deviation parameters comprises calculating the deviation parameters during the scanning of a document to create the image file.

6) The method of claim 1, wherein obtaining the deviation parameters comprises reading the deviation parameters from the image file.

7) The method of claim 1, further comprising reading a control file including manipulation control data indicating the conditions under which an image file will be manipulated.

8) The method of claim 7, wherein the manipulation control data will specify either that (1) the image file will always be manipulated, (2) the image file will never be manipulated, or (3) the image file will be manipulated only when there are deviation parameters available for the image file.

9) The method, as in claim 1, wherein the image file comprises data generated from scanning a response sheet.

10) The method, as in claim 8, wherein the response sheet contains a constructed response.

11) The method, as in claim 1, further comprising writing an error log containing errors that occurred during at least one of the reading step, the obtaining deviation parameters step, and the manipulating step.

12) The method, as in claim 1, wherein the obtaining step comprises:
calculating the deviation parameters on a first computer;
transmitting the calculated deviation parameters from the first computer to a second computer; and
loading the deviation parameters into a computer readable storage medium on the second computer.

13) A system for correcting an image file, comprising:
a processor;
a computer readable storage medium coupled to the processor;
instructions stored on the medium, which, when executed by the processor, cause the processor to:
read into memory a plurality of scanned image files from the storage medium;
obtain deviation parameters describing the extent to which each scanned image file deviates from an idealized captured image;
manipulate one or more of the image files according to the deviation parameters to generate a manipulated image file; and
save each manipulated image file generated to the storage medium.

14) The system, as in claim 13, further comprising a scanner coupled to the processor.

15) The system of claim 13, wherein the deviation parameters include at least one of a horizontal offset, a vertical offset, a horizontal stretch, a vertical stretch, skew, or resolution.

16) The system of claim 13, wherein the instruction to manipulate the image file causes the processor to perform one or more manipulations from the group of manipulations consisting of:
rotating the image to remove skew,
shifting the image left, right, up, and/or down to adjust for horizontal and/or vertical offsets,
stretching or shrinking the image in the horizontal and/or vertical dimensions to adjust for horizontal stretch or shrink and/or vertical stretch or shrink; and
expanding or shrinking the image in the horizontal and/or vertical dimension to adjust the resolution or change the depth of the image.

17) The system of claim 13, wherein instruction to obtain the deviation parameters causes the processor to read the deviation parameters from an index file stored on the storage medium.

18) The system of claim 14, wherein the instructions to obtain the deviation parameters cause the processor to calculate the deviation parameters while the scanning of a document with the scanner to create the image file.

19) The system of claim 13, wherein the instructions to obtain the deviation parameters cause the processor to read the deviation parameters from the image file.

20) The system of claim 13, further comprising instructions stored on the medium which, when executed by the processor, cause the processor to read a control file including manipulation control data indicating the conditions under which an image file will be manipulated.

21) The method of claim 20, wherein the manipulation control data will specify either that (1) the image file will always be manipulated, (2) the image file will never be manipulated, or (3) the image file will be manipulated only when there are deviation parameters available for the image file.

22) The system, as in claim 14, further comprising instructions stored on the medium which, when executed by the processor, cause the processor to write an error log containing errors that occurred during at least one of reading the image files to memory, obtaining the deviation parameters, and manipulating one or more image files.

20) The system, as in claim 14, wherein the instructions to save the image comprise instructions to save a tagged image file format file containing custom tags which include at least one parameter from the set onto the medium.

21) The system, as in claim 14, wherein the instructions to obtain comprise:
instructions to calculate the deviation parameters on a first computer;
instructions to transmit the deviation parameters from the first computer to a second computer; and
instructions to load the deviation parameters into a computer readable storage medium on the second computer.
